(19) United States
(12) Patent Application Publication
(10) Pub. No.: US 2010/0073464 A1
(43) Pub. Date: Mar. 25, 2010

(54) METHOD AND APPARATUS FOR CREATING AND DISPLAYING A THREE DIMENSIONAL IMAGE

(76) Inventor: Robert A. Levine, Guilford, CT (US)

Correspondence Address: O''Shea Getz P.C., 1500 MAIN ST. SUITE 912, SPRINGFIELD, MA, 01115, US

(21) Appl. No.: 12/354,491

(22) Filed: Jan. 15, 2009

Related U.S. Application Data
(60) Provisional application No. 61/100,141, filed on Sep. 25, 2008.

(51) Int. Cl. H04N 13/04

(52) U.S. Cl. 348/51

(57) ABSTRACT

A method for producing stereoscopic views of an object is provided that includes the steps of: a) providing an imaging device having “n” number of independent lenses, where “n” is an integer equal to or greater than two; b) creating “n” number of electronic perspective images of the object using the imaging device, each of which perspective images are created from a vantage point different from the vantage point of the other images, wherein the electronic perspective images are created at substantially the same time, and each electronic perspective image is created through a different one of the “n” number of independent lenses; and c) combining a first of the perspective images and a second of the perspective images into a single electronic collective image within the imaging device, wherein the first perspective image is disposed substantially contiguous with the second perspective image within the electronic collective image.

This disclosure claims priority to, and hereby incorporates in its entirety, U.S. Provisional Application Ser. No. 61/100,141 filed on Sep. 25, 2008.

### BACKGROUND OF THE INVENTION

1. Technical Field

The present invention relates to stereoscopic imagery in general, and to methods and apparatus for making, transmitting and viewing electronic stereoscopic imagery in particular.

2. Background Information

Humans perceive three-dimensional (hereinafter “3D”) objects when the right eye perceives images slightly different than the left eye. The disparity between the perceived images results from a separation, typically between 40 mm and 85 mm, between pupils in the right and the left eyes and hence the images resulting from the two differing perspectives which are then combined by the into a single image that is perceived as 3D.

It is known within the prior art to use a camera to record a first static image of an object at a first vantage point and a second static image of the object at a second vantage point. The term “object” is used herein to refer to whatever imagery can be seen and captured through the lens of the camera. The first and the second images produce first and second negatives, which may further be developed into first and second photographs. To create a 3D image, the first and second negatives, or the first and second photographs, are physically merged by cutting and splicing to form a single frame containing the negatives or the photographs, where the negatives or photographs are disposed side by side within the single frame. The negatives or photographs within the single frame are typically separated from one another by a line or narrow space relative to the image size. The single frame consisting of the two images can then be viewed using a spatial barrier that partially or completely separates the viewing angles of the right and left eyes such that the right eye only sees the image on the right side of the single frame and the left eye only sees the image on the left side of the single frame. This methodology for creating a 3D image is burdensome, time consuming, and costly for creating static images, but is virtually unusable for video presentations due to the numerous frames. Additionally, the post image acquisition joining of the two independent images renders the process very cumbersome and impractical for the viewing and transmission as well as reception of images as they are taken. The present invention resolves these difficulties and facilitates the viewing of a display that is closer than one meter from the views eyes.

### SUMMARY OF THE INVENTION

According to the present invention, a method for producing stereoscopic views of an object, comprising the steps of: a) providing an imaging device having “n” number of independent lenses, where “n” is an integer equal to or greater than two; b) creating “n” number of electronic perspective images of the object using the imaging device, each of which perspective images are created from a vantage point different from the vantage point of the other images, wherein the electronic perspective images are created at substantially the same time, and each electronic perspective image is created through a different one of the “n” number of independent lenses; and c) combining a first of the perspective images and a second of the perspective images into a single electronic collective image within the imaging device, wherein the first perspective image is disposed substantially contiguous with the second perspective image within the electronic collective image. Generally two lenses spaced apart about 40 to 85 mm are sufficient to give a 3D view of objects that are not further than fifty feet, but for distant objects a greater inter-lens distance is preferable. The two perspective images contained in a single collective image greatly facilitate the sending and reception of the 3D image by electronic means since the two images are always synchronized since they are transmitted and received as one image. Upon reception they may be viewed directly with a viewer with a boundary means for separating the left image and directing it to the left eye and the right image to the right eye.

According further to the present invention, an apparatus for producing stereoscopic views of an object is provided that includes “n” number of independent lenses through which the object can be imaged, where “n” is an integer equal to or greater than two, and at least one electronic imaging device. The electronic imaging device is operable to create at least two electronic perspective images of the object through the lenses at substantially the same time, and combine a first of the perspective images and a second of the perspective images into a single electronic collective image. The first perspective image is disposed substantially contiguous with the second perspective image within the electronic collective image. Each lens is positioned relative to the other lenses within the apparatus so that the perspective image of the object created through each lens is created from a vantage point unique to that lens.

One of the advantages of the present method and apparatus is that it provides collective images (each having a first and second perspective image) that enable stereoscopic viewing of an object. Using the present method and apparatus, the collective images can be assembled into a stereoscopic movie, or 3D static images, either of which may be viewed on a host of different display devices such as computer screens, cell phones as long as a barrier can be used to separate the field of view of the user's two eyes. The barrier may be a planar member that separates the fields of view of the user's two eyes and limits each field of view to the respective perspective image, or it may be in a tubular barrier similar to a binocular, etc. In some embodiments, a lens can be used to adjust the focal length between the collective image and the user's eyes. The barrier may be telescoping to adjust its length and may function with or without optical means (e.g., lens). Tubes give separation by creating “tunnel vision” that separates the two perspective images.

In some embodiments, optical means (e.g., prismatic lenses) may be used to move the perspective images laterally to enhance the 3D perception of the collective image. Individual user characteristics (e.g., ocular separation) make it unlikely that a single, fixed lateral separation between the perspective images will be optimal for all viewers. For example, an acceptable lateral separation for some viewers can result in double vision in other viewers. Hence, lateral adjustment can be used to optimize 3D viewing on an individual basis; e.g., it can be used to correct cases of existing double vision due to lack of coordination of the two eyes, such as those caused by ocular muscle imbalance. Although desirable for the aforesaid reasons, lateral adjustment of the two perspective images is not required for the present invention.

Another advantage of lateral adjustment of the perspective views is that both perspective images can be disposed contiguously so that maximal pixel use and resolution can be utilized.

Lateral prismatic adjustment as described above is different from rotational prismatic adjustment that can be used to reorient perspective images that stored are in panoramic view mode; i.e., images presented in such a manner that they must be rotated ninety degrees (90°) to achieve natural orientation. Thus, there can be both a prismatic lateral adjustment to laterally move images (e.g., on a horizontal axis) and a ninety degree (90°) rotational prism. The term “rotational prism” is used herein to mean a prism, mirror, optical means, or electronic means operable to rotate a perspective image ninety degrees (90°) or thereabouts. Beyond the distance of several feet other means of separating the fields of view of the two eyes are needed such as synchronized shutters or polarized or color filters.

Lenses may be incorporated, either fixed or adjustable, in both inter-pupillary distance and diopter so that the near point or preferred point of viewing by the viewer is about 100 mm to 350 mm.

It is therefore an object of this invention to allow single person viewing of 3D static or moving images on a personal viewer. It is a further object of this invention to allow the acquisition and transmission of the two perspective images and their automatic combination and transmission as a single or series of single composite images.

### DESCRIPTION OF THE DRAWINGS

FIG. 1 is a diagrammatic view of the present invention apparatus for producing stereoscopic views of an object. (It appears to me that the camera should be straight and not curved.

FIG. 2 is a diagrammatic view of a first perspective image and a second perspective image within a collective image.

FIG. 3 is a diagrammatic view of a first perspective image and a second perspective image within a collective image, including a separation border disposed between the perspective images.

FIG. 4 is a diagrammatic view of a first perspective image and a second perspective image within a collective image shown in panoramic form.

FIG. 5 is a diagrammatic side view of a display device, barrier, and holder.

FIG. 6 is a diagrammatic planar view of a display device, barrier, and holder.

### DETAILED DESCRIPTION OF THE INVENTION

The present invention includes an apparatus 8 for producing stereoscopic views of an object. The term “object” is used herein to describe anything, static or dynamic, that can be captured as an image in an image-recording device such as an electronic digital camera and the software associated with the camera.

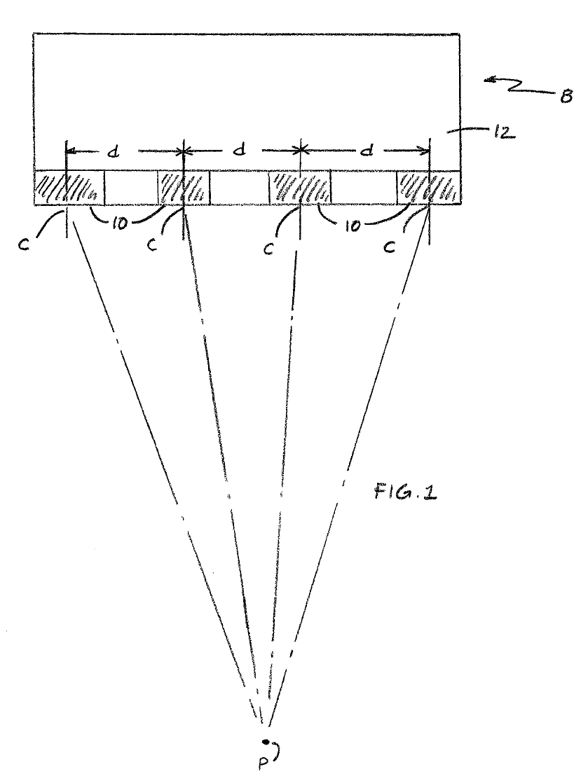

FIG. 1 is a diagrammatic view of the present apparatus, which includes “n” number of independent lenses 10 through which an object can be imaged, where “n” is an integer equal to or greater than two, and at least one electronic imaging device 12.

The lenses 10 may be of any type that can be used with an electronic imaging system such as a digital camera. The specific characteristics (e.g., magnification, filtering, etc.) of each of the lenses 10 can vary depending on the application. In some applications, all of the lenses 10 are identical. In other applications, there is more than one type of lens 10 within the “n” number of lenses 10. Each lens 10 is formed such that a perspective image of the object can be acquired through the lens 10. Each lens 10 is positioned relative to the other lenses 10 within the apparatus 8 so that the perspective image of the object created through each lens 10 is created from a vantage point unique to that lens 10, and therefore different from the vantage points of the other lenses 10.

Each lens 10 has an optical center “C”. The optical centers of any two of the lenses 10 may be described as being laterally separated by a distance “d”. In some embodiments, the distance “d” may be equal to the typical distance separating the pupils in pair of human eyes (e.g. approximately 63 mm). In some applications, the distance between pairs of lenses 10 within the “n” number of lenses 10 may be varied to provide different vantage points. All of the lenses 10 are preferably focused on the same focal point “P”.

The electronic imaging device 12 is any device that is operable to simultaneously record “n” number of electronic perspective images of the object at a particular time. The “n” perspective images are presented to the electronic imaging device 12 through the “n” number of lenses 10. An example of an acceptable type device is a digital camera. Digital cameras are well known in the art and therefore will not be described in further detail here.

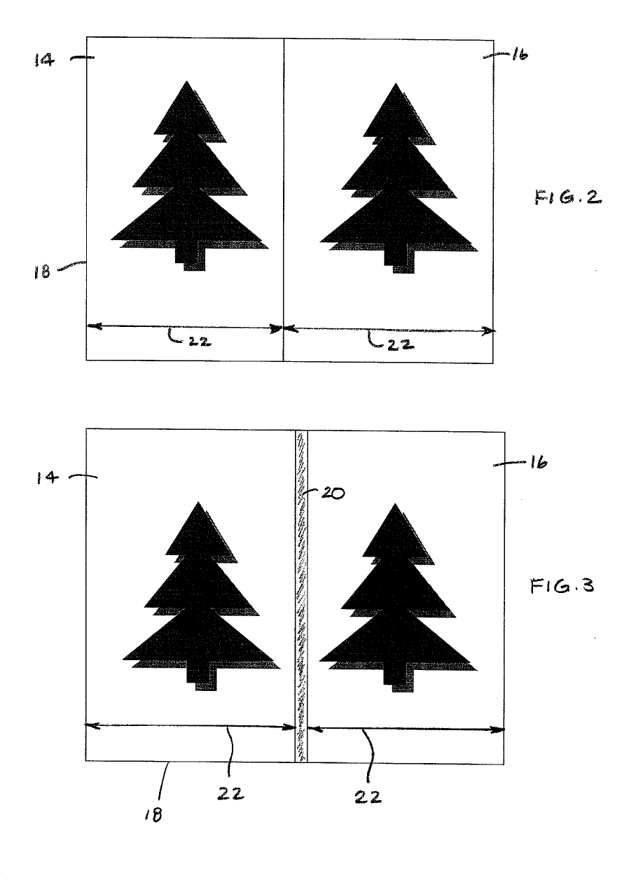

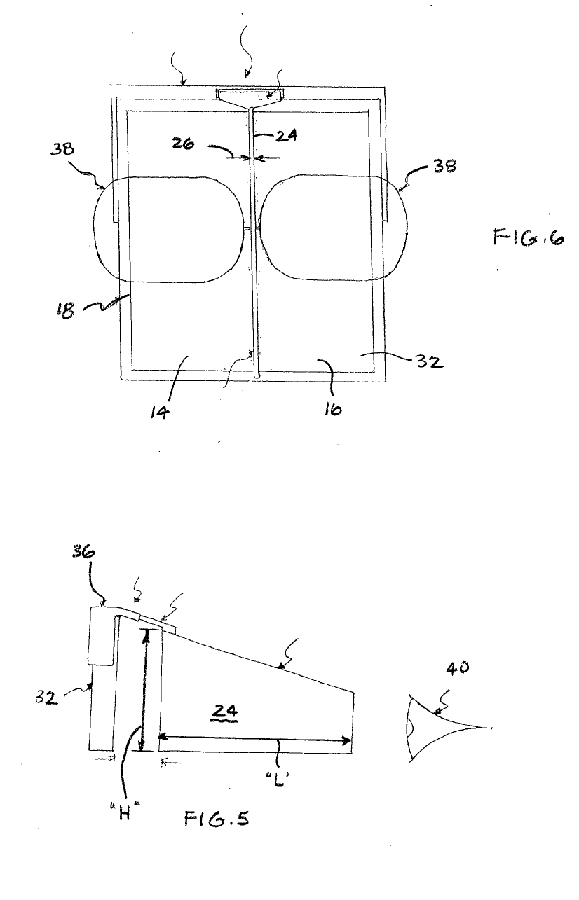

Referring to FIGS. 1-4, the electronic imaging device 12 includes a processor operable to combine a first perspective image 14 and a second perspective image 16 into a single electronic collective image 18 within the imaging device 12. The electronic images 14, 16, 18 can be in any format that can be stored and reproduced; e.g., formats produced by a digital camera. In the collective image, the first perspective image 14 is disposed substantially contiguous with the second perspective image 16. The term “substantially contiguous” is used herein to describe that the perspective images 14, 16 are either touching each other (e.g., side border to side border) within a collective image 18, or arrangements where the perspective images 14, 16 are separated from each other by a separation border 20 (see FIG. 3) that is very narrow relative to the widths 22 of the perspective images 14, 16. As will be described below, collective images 18 can be viewed with a device that includes a barrier 24 (see FIGS. 5 and 6) having a thickness 26. In those instances where a separation border 20 is disposed between the perspective images 14, 16, it is preferable that the separation border 20 is equal to or less than the thickness 26 of the barrier 24.

The electronic imaging device 12 includes means for storing the recorded electronic images, both perspective and collective. The storage means may be integral with the device or in a form that can be removed from the device; e.g., memory card or stick. The stored images may be accessed as individual perspective views or as collective views.

The electronic imaging device 12 also includes the ability to view the images 14, 16, 18 in different resolution modes; e.g., greater or lesser number of pixels per unit area. The higher resolution modes can be used to focus in on certain portions of the collective image 18 (e.g., one of the perspective views 14, 16), or focus in on a certain portion of a perspective view 14, 16.or to view the same field of view with greater resolution.

The electronic imaging device 12 may include a transmitter operable to transfer stored electronic images to a remote device for receiving the recorded images. The remote device may be connected to the electronic imaging device 12 by wire, or may be connected via a wireless network.

The electronic imaging device 12 can be operated in a “one shot” mode wherein “n” electronic perspective images of an object are simultaneously recorded for a static depiction of the object within a collective image. The electronic imaging device 12 can also be operated in a continuous recording mode wherein perspective images 14, 16, and the collective image 18 created therefrom, are created at a rate of “x” frames per second. In preferred embodiments, a continuous recording rate of at least fifteen frames per second (i.e., 15 fps) is used to produce a desirable continuous motion recording of the object.

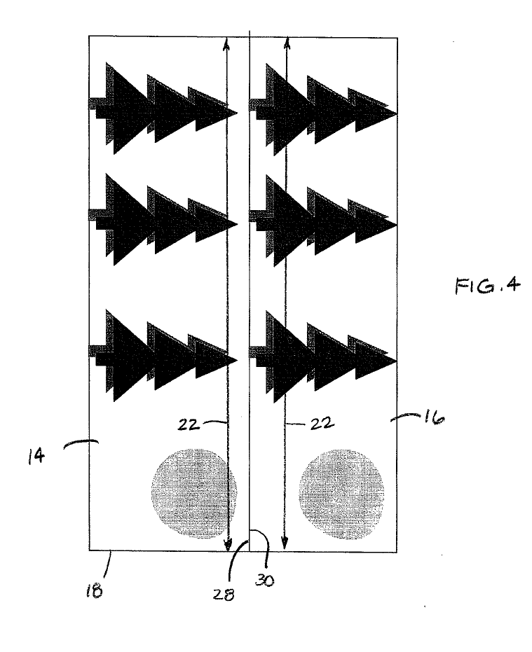

Referring to FIGS. 1 and 4, the electronic imaging device 12 may also be operated in a panoramic view mode. In this mode, the width 22 of the perspective images 14, 16 can be oriented to extend along a long axis of the collective image 18, to give the impression of a panoramic view. The perspective views 14, 16 can be oriented within the collective image 18 so that the top border 28 of one perspective view 16 is substantially contiguous with the bottom border 30 of the other perspective view 14. The perspective images are viewed with one eye seeing one perspective image and the other eye seeing the other perspective image. To display the two panoramic views, the display of each of the two perspective images must be rotated ninety degrees (90°) into its natural orientation (i.e., where vertical is defined by a gravitational vector and horizontal is normal to vertical). Depending upon how the collective image 18 is oriented, the viewing device 12 will include optics (e.g., prisms or mirrors) or electronic means (e.g., programming) operable to rotate the perspective images 14, 16 ninety degrees (90°) to create the natural orientation of the panoramic view. The advantage of optical means is that the full number of pixels may be used for the electronic images and that no pixels are wasted in the space between the two images. Either optical and or electronic lateral positioning of the images may be employed.

Now referring to FIGS. 5 and 6, the electronic imaging device 12 may be connected to a display device 32 for real-time viewing of the recorded images, or stored recorded images may be transferred to a display device 32 at a later point in time. The recorded images can be displayed on a variety of display types, including those utilized with cellular phones, televisions, computers, etc. The display device 32 may be signally coupled to the electronic imaging device 12 by wired or wireless connection, or the recorded images may be transferred from a storage medium. The display is operable to display either perspective image 14, 16, or the collective image 18 in the “one shot” mode or in the continuous mode.

To stereoscopically view the collective images, a barrier 24 can be used in combination with the display device 32. The barrier 24 is operable to substantially separate fields of vision between the right and the left eyes of the viewer in a manner so that one eye 40 of the viewer sees the first perspective image 14 and the other eye of the viewer sees the second perspective image 16.

The barrier 24 has a length “L” and a height “H” and may be made of a substantially opaque material; i.e., a material that cannot be seen through. The barrier 24 may be positioned between the eyes 40 of a user, extending toward a display device 32 in a manner that at least substantially separates the fields of vision for the first and second perspective images 14, 16. The length “L” of the barrier 24 is typically in the range of 75 mm to 200 mm, but can vary depending upon the application. The barrier 24 is preferably, but not necessarily, planar. In some embodiments, the barrier 24 may telescopically extend or contract. In other embodiments, the barrier 24 may be folded or unfolded to extend or contract. The barrier may also consist of two tubular structures either complete tubes or with their lateral walls open for viewer comfort.

In some embodiments, a holder 36 can be used to relatively position and hold the barrier 24 relative to the display device 32. The holder 36 can include mechanical attachment means to attach the barrier 24 and/or the display device 32 to the holder 36. In some embodiments, the holder 36 may include means for adjusting the distance between the barrier 24 and the display 32.

In other embodiments, one or more vision alteration devices 38 (e.g., lenses, filters, etc.) may be attached to one of the barrier 24 or the holder 36. Optical lenses 38 can be used, for example, to adjust the focal distance between the viewer's eyes relative to the display device 32. In addition, lenses 38 can be used to adjust the inter-pupillary distance, or otherwise adjust how the image is being viewed to increase viewer comfort (e.g., reduce eye strain) or increase three-dimensional (3D) effect.

The above described apparatus 8 may be used in a method for producing stereoscopic views of an object. The method includes: a) providing an imaging device having “n” number of independent lenses 10, where “n” is an integer equal to or greater than two; b) creating at least two electronic perspective images of the object using the imaging device 12, each of which perspective images are created from a vantage point different from the vantage point of the other images, wherein the electronic perspective images are created at substantially the same time, and each electronic perspective image is created through a different one of the “n” number of independent lenses 10; and c) combining a first of the perspective images and a second of the perspective images into a single electronic collective image within the imaging device 12, wherein the first perspective image is disposed substantially contiguous with the second perspective image within the electronic collective image. As indicated above, collective images may be recorded in “one-shot” mode, or may be continuously recorded at a desirable rate of “x” frames per second.

The collective images may be displayed on a display device 32 integrated with, or independent of, the electronic imaging device 12 in real-time with the recording, or subsequently from stored images.

To get the stereoscopic view effect, a viewer may position a barrier 24 between his eyes and the display 32, in a manner that at least partially separates the perspective images disposed within the collective image. In this configuration, the viewer's right eye has a line of sight to one of the perspective images 16 and the left eye has a line of sight to the other of the perspective images 14. The brain of the viewer combines the vision from the right eye with the vision from the left eye and therefore perceives a single 3D image. Adjustment of the lateral position of the two images may be needed by individuals to achieve 3D effect.

While various embodiments of the 3D imaging apparatus 8 have been described, it will be apparent to those of ordinary skill in the art that many more embodiments and implementations are possible within the scope of the 3D imaging apparatus 8.

What is claimed is:

1. A method for producing stereoscopic views of an object, comprising the steps of:
providing an imaging device having “n” number of independent lenses, where “n” is an integer equal to or greater than two;
creating at least two electronic perspective images of the object using the imaging device, each of which perspective images are created from a vantage point different from the vantage point of the other perspective images, wherein the electronic perspective images are created at substantially the same time, and each electronic perspective image is created through a different one of the “n” number of independent lenses; and
combining a first of the perspective images and a second of the perspective images into a single electronic collective image within the imaging device, wherein the first perspective image is disposed substantially contiguous with the second perspective image within the electronic collective image.

2. The method of claim 1, further comprising the step of storing the collective image within the imaging device.

3. The method of claim 1, further comprising the step of storing a plurality of collective images in sequential order to permit viewing of the collective images in a time sequential manner.

4. The method of claim 3, further comprising the step of transmitting the collective images to a receiver remotely located from the apparatus.

5. The method of claim 4, wherein the collective images are transmitted over a wireless network.

6. The method of claim 1, further comprising the step of transmitting the collective image to a receiver remotely located from the apparatus.

7. The method of claim 6, wherein the collective image is transmitted over a wireless network.

8. The method of claim 1, wherein the single electronic images are created at a frame rate of at least fifteen frames per second.

9. The method of claim 1, further comprising the step of storing the single electronic collective image file in a manner that allows each perspective image to be viewed independent of the other perspective views and of the collective image file.

10. The method of claim 9, wherein each perspective image may be viewed in greater resolution than the collective image.

11. The method of claim 1, further comprising the step of storing the single electronic collective image files in a manner that allows each perspective image to seen as a panoramic view.

12. The method of claim 11, further comprising the step of reorienting each of the panoramic perspective images to its natural orientation.

13. The method of claim 1, further comprising the steps of displaying the collective image, and providing lateral positioning adjustment for the perspective images within the displayed collective image.

14. An apparatus for producing stereoscopic views of an object, comprising:
“n” number of independent lenses through which the object can be imaged, where “n” is an integer equal to or greater than two; and
at least one electronic imaging device operable to create at least two electronic perspective images of the object through the lenses at substantially the same time, and combine a first of the perspective images and a second of the perspective images into a single electronic collective image, wherein the first perspective image is disposed substantially contiguous with the second perspective image within the electronic collective image;
wherein each lens is positioned relative to the other lenses within the apparatus so that the perspective image of the object created through each lens is created from a vantage point unique to that lens.

15. The apparatus of claim 14, wherein the electronic imaging device includes storage medium for storing collective images.

16. The apparatus of claim 15, wherein the electronic imaging device includes a transmitter for transmitting collective images to a receiver remotely located from the apparatus.

17. The apparatus of claim 16, wherein the transmitter is operable to transmit collective images over a wireless network.

18. The apparatus of claim 14, wherein the electronic imaging device is operable to create collective images at a frame rate of at least fifteen frames per second.

19. The apparatus of claim 14, wherein the at least one electronic imaging device is operable to create at least two electronic perspective images of the object through the lenses at substantially the same time in a panoramic view mode.

20. The apparatus of claim 19, further comprising a display for viewing collective images, and means for reorienting each of the panoramic perspective images to permit each of the panoramic perspective views to be seen on the display in its natural orientation.

21. The apparatus of claim 14, further comprising a display for viewing collective images, and means for adjusting the lateral position of the perspective images within the displayed collective images.

22. A method for providing stereoscopic views of an object, comprising the steps of:
creating at least two electronic perspective images of the object using a single imaging device, each of which perspective images is created from a vantage point different from the vantage point of the other perspective images, wherein the electronic perspective images are created at substantially the same time, and each electronic perspective image is created through a different lens associated with the imaging device;
combining a first of the perspective images and a second of the perspective images into a single electronic collective image within the imaging device, wherein the first perspective image is disposed substantially contiguous with the second perspective image within the electronic collective image; and
sending the collective image to a display device operable to concurrently display both perspective images within the collective image.
